(19) United States
(12) Patent Application Publication
(10) Pub. No.: US 2024/0261891 A1
(43) Pub. Date: Aug. 8, 2024

(54) LASER PROCESSING DEVICE AND LASER PROCESSING METHOD

(71) Applicant: TOKYO SEIMITSU CO., LTD., Tokyo (JP)

(72) Inventor: Yusuke ARAI, Hachioji-shi (JP)

(21) Appl. No.: 18/406,628

(22) Filed: Jan. 8, 2024

(30) Foreign Application Priority Data
Feb. 7, 2023 (JP) 2023-016987

(51) Int. Cl. B23K 26/042; B23K 26/03; B23K 26/06; B23K 26/0622; B23K 26/53

(52) U.S. Cl. CPC B23K 26/042; B23K 26/032; B23K 26/0622; B23K 26/0648; B23K 26/53

(57) ABSTRACT

Provided are a laser processing device and a laser processing method capable of evaluating a processing state of laser processing for a workpiece in real time.

A laser processing device 10 that irradiates a workpiece with laser light by aligning light-focusing points from a laser bead 16 to an inside of the workpiece while moving the laser head 16 relative to the workpiece (a wafer W) and executes laser processing of forming laser processing areas SP1 and SP2 inside the workpiece along a street of the workpiece, includes a detection sensor (photodiodes 20 and 36) configured to detect plasma light generated at a processing point of the laser light that is focused on the inside of the workpiece by the laser head during the laser processing, and an evaluation unit 48 configured to evaluate a processing state of the laser processing area on the basis of a detection signal of the detection sensor during the laser processing.

### BACKGROUND OF THE INVENTION

### Field of the Invention

The present invention relates to a laser processing device and a laser processing method that form a laser processing area within a workpiece along a street of the workpiece. Priority is claimed on Japanese Patent Application No. 2023-016987, filed Feb. 7, 2023, the content of which is incorporated herein by reference.

### Description of Related Art

A silicon wafer (hereinafter called a wafer), which is a workpiece, has a plurality of devices divided into grid-like streets (also called processing lines or planned cutting lines), and individual devices are manufactured by cutting (dividing) the wafer along the streets. As a pre-process of cutting the wafer into a plurality of devices (chips), laser processing of the wafer is executed using a laser processing device.

For example, the laser processing devices described in Patent Document 1 and Patent Document 2 emit laser light to the inside of the wafer along the streets with the light-focusing points aligned, and execute laser processing (also referred to as internal light focusing processing) of forming a laser processing area, that is a starting point of cutting, inside the wafer along the streets. As a result, cracks (also referred to as cracks) extend from the laser processing area in a thickness direction of the wafer, so that the wafer is cut into individual devices (chips) in the cutting process that is a post-process.

### PATENT DOCUMENTS

[Patent Document 1] Japanese Unexamined Patent Application, First Publication No. 2016-107334
[Patent Document 2] Japanese Unexamined Patent Application, First Publication No. 2016-21519

### SUMMARY OF THE INVENTION

When a laser processing area is formed inside a wafer by laser processing using the laser processing devices described in Patent Document 1 and Patent Document 2, if an extension state (length, etc.) of a crack extending from this laser processing area is appropriate, the wafer is appropriately cut into each device (chip) in the cutting process that is a post-process. On the other hand, if the laser processing conditions are not sufficient, the crack extension from the laser processing area will be weakened, and a cut line after cutting will meander or chipping may occur. In particular, at an intersection of lattice-shaped streets, cracks extending from the laser processing area formed by the previous laser processing cause the laser light to be scattered during the subsequent laser processing, and thereby the crack extension from the laser processing area is easily weakened. Additionally, if an intensity of the laser light is too strong, there is a risk that residue generated during the laser processing will adhere to the objective lens of the laser head, causing lens stains.

Therefore, it is necessary to set conditions for laser processing so that the crack extension state is appropriate. In this case, conventionally, it has been necessary to execute laser processing on a sample wafer and to cut the sample wafer to actually check cracks in the cross-section. Alternatively, conventionally, each device is inspected using an image inspection device after wafer cutting to check whether there is an abnormality in the processing state (crack extension state) of the laser processing. In this manner, conventionally, it has not been possible to detect changes in the processing state of a product wafer in real time during the laser processing.

In addition, when laser processing on a plurality of wafers is executed by the laser processing device, processing defects may occur due to abnormalities in the thickness of the wafers or abnormalities in the processing height control of the laser processing by the laser processing device. If such a processing defect occurs during the laser processing, a laser processing area may not be generated inside the wafer by a focus of the laser light shifting away from the inside of the wafer. In this case, the wafer cannot be divided into individual pieces in the post-process (the wafer is not divided), and the device is discarded, which results in a decrease in a yield of device mass production processing. For this reason, it is required to detect the processing state (whether a laser processing area is formed inside the wafer) in real time during the laser processing of the product wafer.

The present invention has been made in view of these circumstances, and an object thereof is to provide a laser processing device and a laser processing method that can evaluate a processing state of laser processing for a workpiece in real time.

To achieve the object of the present invention, a laser processing device that irradiates a workpiece with laser light by aligning light-focusing points from a laser head to an inside of the workpiece while moving the laser head relative to the workpiece and executes laser processing of forming a laser processing area inside the workpiece along a street of the workpiece, includes a detection sensor configured to detect plasma light generated at a processing point of the laser light that is focused on the inside of the workpiece by the laser head during the laser processing and an evaluation unit configured to evaluate a processing state of the laser processing area on the basis of a detection signal of the detection sensor during the laser processing.

According to this laser processing device, it is possible to evaluate the processing state of the laser processing area in real time during the laser processing.

In the laser processing device according to the aspect of the present invention, the detection sensor may be provided separately from the laser head. As a result, it is possible to directly detect plasma light generated inside a workpiece using a detection sensor.

In the laser processing device according to the aspect of the present invention, the laser head may include a light source that emits the laser light, an objective lens that focuses the laser light emitted from the light source on the inside of the workpiece, and an optical branching element that is disposed on an optical path of the laser light incident on the objective lens and causes a part of the plasma light incident on the objective lens from the workpiece to branch from the optical path, and the detection sensor may be provided in the laser head and detect the plasma light branched by the optical branching element. As a result, it is possible to detect the plasma light generated inside the workpiece using the detection sensor even when a work distance of the laser head to the workpiece cannot be sufficiently ensured.

In the laser processing device according to the aspect of the present invention, the laser head may include a light source that emits the laser light, an objective lens that focuses the laser light emitted from the light source on the inside of the workpiece, and an optical branching element that is disposed on an optical path of the laser light incident on the objective lens and causes a part of the plasma light incident on the objective lens from the workpiece to branch from the optical path, and the detection sensor may include a first detection sensor that is provided separately from the laser head, and a second detection sensor that is provided in the laser head and detects the plasma light branched by the optical branching element. As a result, it is possible to detect the plasma light generated inside the workpiece using two types of detection sensors.

In the laser processing device according to the aspect of the present invention, the workpiece may have a plurality of first streets and a plurality of second streets intersecting each other to form a lattice shape, the laser processing may include first laser processing of forming the laser processing area inside the workpiece along the first street for each of the first streets, and second laser processing of forming the laser processing area inside the workpiece along the second street for each of the second streets after completion of the first laser processing, and the evaluation unit may evaluate whether the laser processing area is formed at an intersection of the first street and the second street by the second laser processing as the processing state during the second laser processing. As a result, it is possible to evaluate whether the laser processing area is formed at the intersection of the first street and the second street by the second laser processing.

In the laser processing device according to the aspect of the present invention, the laser light may be pulse laser light, and the evaluation unit may execute evaluation of the processing state on the basis of a result of detecting at least one of a light emission period, a light emission intensity, a light emission timing, and a light emission time of the plasma light based on the detection signal of the detection sensor.

The laser processing device according to the aspect of the present invention further includes a correction control unit configured to correct emission conditions of the laser light emitted from the laser head on the basis of a detection signal of the detection sensor during the laser processing, and to keep a constant light emission state of the plasma light generated at the processing point. As a result, it is possible to keep a constant processing state of the laser processing area by correcting the emission conditions of the laser light in real time during the laser processing.

To achieve the object of the present invention, a laser processing device that irradiates a workpiece with laser light by aligning light-focusing points from a laser head to an inside of the workpiece while moving the laser head relative to the workpiece and executes laser processing of forming a laser processing area inside the workpiece along a street of the workpiece, includes a detection sensor configured to detect plasma light generated at a processing point of the laser light that is focused on the inside of the workpiece by the laser head during the laser processing, an evaluation unit configured to evaluate a processing state of the laser processing area on the basis of a detection signal of the detection sensor during the laser processing, and a correction control unit configured to correct emission conditions of the laser light emitted from the laser head on the basis of a detection signal of the detection sensor during the laser processing, and to keep a constant light emission state of the plasma light generated at the processing point.

According to this laser processing device, it is possible to keep a constant processing state of the laser processing area by correcting the emission conditions of the laser light in real time during the laser processing.

To achieve the object of the present invention, a laser processing method of irradiating a workpiece with laser light by aligning light-focusing points from a laser head to an inside of the workpiece while moving the laser head relative to the workpiece and executing laser processing of forming a laser processing area inside the workpiece along a street of the workpiece, includes a detection process of detecting plasma light generated at a processing point of the laser light that is focused on the inside of the workpiece by the laser head during the laser processing and an evaluation process of evaluating a processing state of the laser processing area on the basis of a detection signal detected in the detection process during the laser processing.

To achieve the object of the present invention, a laser processing method of irradiating a workpiece with laser light by aligning light-focusing points from a laser head to an inside of the workpiece while moving the laser head relative to the workpiece and executing laser processing of forming a laser processing area inside the workpiece along a street of the workpiece, includes a detection process of detecting plasma light generated at a processing point of the laser light that is focused on the inside of the workpiece by the laser head during the laser processing, and a correction control process of correcting emission conditions of the laser light emitted from the laser head on the basis of a detection signal detected in the detection process during the laser processing, and keeping a constant light emission state of the plasma light generated at the processing point.

In the present invention, it is possible to evaluate a processing state of laser processing for a workpiece in real time. In addition, since it is possible to check in real time whether a laser processing area is formed inside a wafer, a yield of device mass production processing can be improved.

### BRIEF DESCRIPTION OF THE DRAWINGS

FIG. 1 is a schematic view of a laser processing device according to a first embodiment.

FIG. 2 is a plan view of a wafer to be processed by the laser processing device.

FIG. 3 is a cross-sectional view of a part of the wafer shown in FIG. 2.

FIG. 4 is a functional block diagram of a control device of the first embodiment.

FIG. 5 is a diagram for describing a formation of a laser processing area inside the wafer.

FIG. 6 is a diagram for describing the formation of the laser processing area inside the wafer.

FIG. 7 is a diagram for describing a formation of a plurality of layers of laser processing areas inside the wafer.

FIG. 8 is a diagram for describing the formation of a plurality of layers of laser processing areas inside the wafer.

FIG. 9 is a flowchart which shows a flow of laser processing of the wafer by the laser processing device of the first embodiment.

FIG. 10 is a flowchat which shows a flow of processing of step S5 in FIG. 9.

FIG. 11 is a diagram for describing laser processing of a first layer on a street CH2, which is executed near an intersection after laser processing of two layers on a street CH1.

FIG. 12 is a diagram for describing laser processing of a second layer on the street CH2, which is executed near an intersection after laser processing of two layers on the street CH1.

FIG. 13 is a diagram for describing the laser processing of the second layer on the street CH2, which is executed near the intersection after the laser processing of two layers on the street CH1.

FIG. 14 is a diagram for describing the laser processing of the second layer on the street CH2, which is executed near the intersection after the laser processing of two layers on the street CH1.

FIG. 15 is a diagram which shows a laser processing device of a second embodiment.

FIG. 16 is a diagram which shows a laser processing device of a third embodiment.

FIG. 17 is a diagram which shows a laser processing device of a fourth embodiment.

### DETAILED DESCRIPTION OF THE INVENTION

### First Embodiment

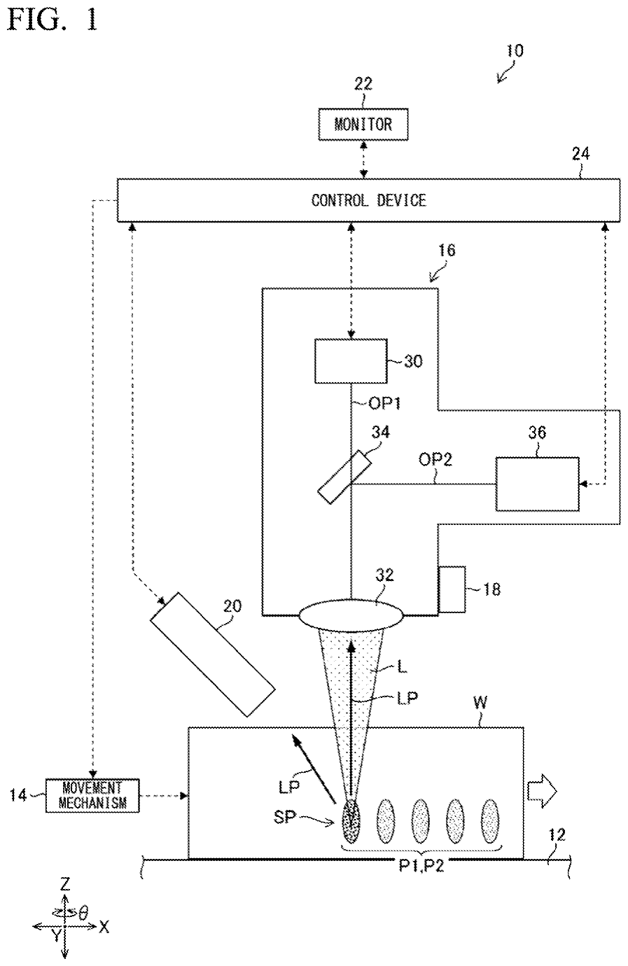

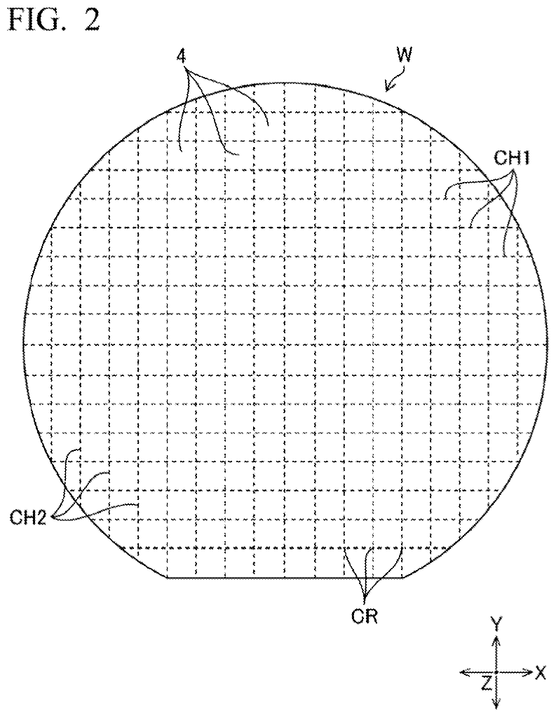

FIG. 1 is a schematic view of a laser processing device 10 according to a first embodiment. As shown in FIG. 1, the laser processing device 10 performs laser processing (internal light focusing processing) on a wafer W (for example, a silicon wafer), which is a workpiece, as a pre-process of a cutting process of cutting the wafer into a plurality of chips 4 (refer to FIG. 2). Note that XYZ directions in drawings are orthogonal to each other, of which X and Y directions are horizontal directions, and a Z direction is a vertical direction (a thickness direction of the wafer W). In addition, a θ direction is a rotation direction with the Z direction as a rotation axis.

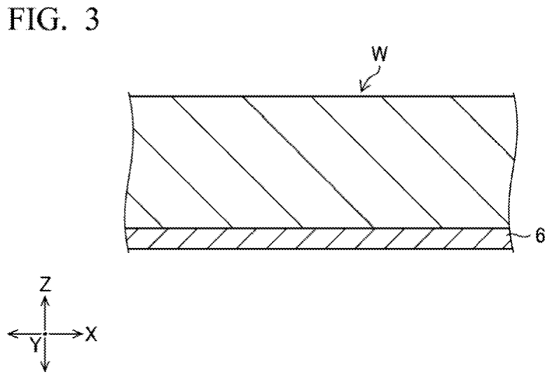

FIG. 2 is a plan view of the wafer W to be processed by the laser processing device 10. FIG. 3 is a cross-sectional view of a part of the wafer W shown in FIG. 2. As shown in FIGS. 2 and 3, the wafer W is a product wafer. In this wafer W, a plurality of streets CH1 and a plurality of streets CH2 are formed in a lattice shape to intersect with each other. As a result, the wafer W is divided into a plurality of areas by the streets CH1 and CH2. A device layer 6 constituting the chip 4 is provided in each of the divided areas. Note that the streets CH1 correspond to first streets of the present invention, and the streets CH2 correspond to second streets of the present invention. Moreover, a symbol CR in FIG. 2 is an intersection between a street CH1 and a street CH2.

The laser processing device 10 first forms a laser processing area P1 inside the wafer W along the street CH1 for each street CH1, and then forms a laser processing area P2 inside the wafer W along the street CH2 for each street CH2 by laser processing.

Returning to FIG. 1, the laser processing device 10 includes a table 12 (also referred to as an XYZθ stage), a movement mechanism 14, a laser head 16, an infrared camera 18, a photodiode 20, a monitor 22, and a control device 24.

The table 12 is a chuck table that adsorbs and holds a surface of the wafer W on the side where the device layer 6 is provided via a back grind tape (not shown) or the like. As a result, the wafer W is held on the table 12 so that the back surface opposite to the surface faces the laser head 16, which will be described below.

The movement mechanism 14 is constituted by an actuator, a motor, and the like, and causes the table 12 to move in the XYZ directions or causes it to rotate in the H direction under the control device 24 described below. The movement mechanism 14 causes the table 12 to move in an X direction (a processing feed direction) during the laser processing. Note that the movement mechanism 14 is not particularly limited as long as it can cause the laser head 16 to move relative to the table 12 and the wafer W in the XYZθ directions, and may cause, for example, the laser head 16 to move.

The laser head 16 is disposed at a position above the table 12 in the Z direction (a position facing the back surface of the wafer W), and is controlled by the control device 24, which will be described below. This laser head 16 aligns a light-focusing point inside the wafer W and irradiates the wafer W with laser light L, thereby forming a laser processing area P1 inside the wafer W along the street CH1 and forming a laser processing area P2 inside the wafer W along the street CH2.

The laser head 16 includes a laser light source 30, an objective lens 32, a half mirror 34, and a photodiode 36.

The laser light source 30 emits laser light L (pulse laser light) for laser processing. Conditions for the laser light source 30 and the laser light L include, for example, the laser light source 30 being a semiconductor laser excitation Nd:YAG laser, the wavelength being 1.1 μm, the laser light spot cross-sectional area being 3.14×10⁻⁸ cm², the oscillation form being a Q-switch pulse, the repetition frequency being 80 to 120 kHz, the pulse width being 180 to 280 ns, and the output being 8 W.

The objective lens 32 focuses the laser light L emitted from the laser light source 30 inside the wafer W. As a result, the laser processing areas P1 and P2 are formed inside the wafer W by laser processing. In addition, at a processing point SP of laser processing, a plume (steam) is generated, and plasma light LP is generated when this plume is heated by the laser light.

The half mirror 34 corresponds to an optical branching element of the present invention, and is disposed in an optical path OP1 of the laser light L between the laser light source 30 and the objective lens 32, that is, the optical path OP1 of the laser light L incident on the objective lens 32. This half mirror 34 causes an optical path OP2 to branch from the optical path OP1. As a result, the half mirror 34 causes a part of the plasma light LP that is incident from the inside of the wafer W via the objective lens 32 to branch into the optical path OP2, thereby allowing the plasma light LP to be incident on the photodiode 36. Note that a known optical branching element (a beam splitter) such as a prism may be used instead of the half mirror 34.

The photodiode 36 corresponds to the detection sensor and the second detection sensor of the present invention, and is disposed in the optical path OP2. This photodiode 36 detects (photoelectrically converts) a part of the plasma light LP branching by the half mirror 34, and outputs a detection signal of the plasma light LP to a control device 24, which will be described below.

The infrared camera 18 is provided integrally with (or separately from) the laser head 16. This infrared camera 18 photographs an alignment reference formed on the wafer W before laser processing is performed on the wafer W. and outputs photographed image data of this alignment reference to the control device 24. The alignment reference here is a reference by which the laser processing device 10 recognizes positions of the streets CH1 and CH2 of the wafer W, and, for example, the streets CH1 or CH2 or a known reference such as an alignment mark (not shown) is used. Note that the alignment reference may be provided at any position such as inside, on the surface, on the back surface, and the like of the wafer W, as long as it can be photographed by the infrared camera 18.

The photodiode 20 corresponds to a detection sensor and a first detection sensor of the present invention, and is provided separately from the laser head 16. The photodiode 20, unlike the photodiode 36 described above, directly detects the plasma light LP generated inside the wafer W (detects it without involving the objective lens 32, or the like), and outputs a detection signal of this plasma light LP to a control device 24, which will be described below. Note that a position and an angle (posture) of the photodiode 20 are adjusted in advance so that the plasma light LP can be detected. Moreover, a plurality of photodiodes 20 may also be provided.

The monitor 22 displays photographed image data input from the infrared camera 18, various setting screens of the laser processing device 10, and the like.

The control device 24 generally controls an operation of each part of the laser processing device 10, such as the movement mechanism 14, the laser head 16 (the laser light source 30 and the photodiode 36), the infrared camera 18, and the photodiode 20. As a result, the control device 24 controls an alignment of the laser head 16 with respect to the wafer W, laser processing for each of the streets CH1 and CH2, an evaluation of processing states of the laser processing areas P1 and P2, a correction of emission conditions of the laser light L from the laser light source 30, and the like.

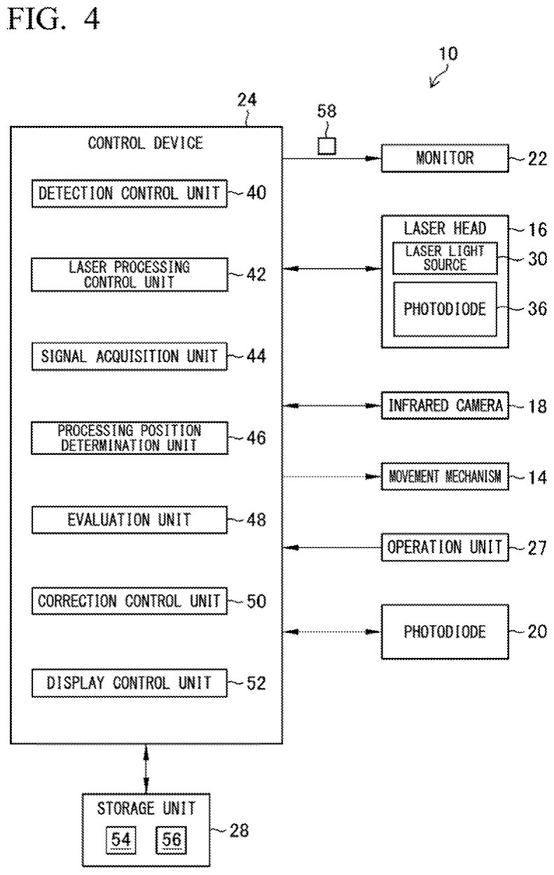

FIG. 4 is a functional block diagram of the control device 24 of the first embodiment. As shown in FIG. 4, an operation unit 27 and a storage unit 28, in addition to the movement mechanism 14, the laser head 16 (the laser light source 30 and the photodiode 36), the infrared camera 18, and the photodiode 20, which have been described, are connected in the control device 24.

A keyboard, a mouse, an operation button, and the like, which are known, are used as the operation unit 27, and receive an input of various types of operations from an operator.

In addition to the control program (not shown) of the control device 24, the storage unit 28 stores a data table for evaluation 54 and a data table for correction 56. The data table for evaluation 54 is used for evaluation of the processing state of laser processing by an evaluation unit 48, which will be described below. The data table for correction 56 is used for correction of the emission conditions of the laser light L from the laser light source 30, which is executed by a correction control unit 50, which will be described below.

The control device 24 is constituted by an arithmetic device such as a personal computer, and includes an arithmetic circuit constituted from various processors, memories, and the like. Various processors include a central processing unit (CPU), a graphics processing unit (GPU), an application specific integrated circuit (ASIC), a programmable logic device [for example, a simple programmable logic device (SPLD), a complex programmable logic device (CPLD), and a field programmable gate array (FPGA)], and the like. Note that various functions of the control device 24 may be realized by one processor, or may be realized by a plurality of processors of the same type or different types.

By executing a control program (not shown), the control device 24 functions as a detection control unit 40, a laser processing control unit 42, a signal acquisition unit 44, a processing position determination unit 46, an evaluation unit 48, a correction control unit 50, and a display control unit 52. Hereinafter, in the present embodiment, something described as a “unit” may be a “circuit,” an “apparatus,” or “equipment.” That is, something described as a “unit” may be constituted by firmware, software, hardware, or a combination thereof.

The detection control unit 40 controls each part of the laser processing device 10 and executes alignment detection to detect the positions (including the orientations in an XY plane) of the streets CH1 and CH2 of the wafer W held in the table 12.

First, the detection control unit 40 controls the movement mechanism 14 and the infrared camera 18 to obtain the photographed image data of the alignment reference of the wafer W. For example, the detection control unit 40 drives the movement mechanism 14 on the basis of known design information of the wafer W to cause the infrared camera 18 to move relative to a position where the alignment reference of the wafer W can be photographed. After this movement, the detection control unit 40 causes the infrared camera 18 to execute photographing of the wafer W including the alignment reference. As a result, the photographed image data of the alignment reference of the wafer W is acquired by the infrared camera 18, and this photographed image data is output from the infrared camera 18 to the detection control unit 40.

Next, the detection control unit 40 detects the positions of each of the streets CH1 and CH2 of the wafer W by detecting the alignment reference from the photographed image data input from the infrared camera 18 using a known image recognition method.

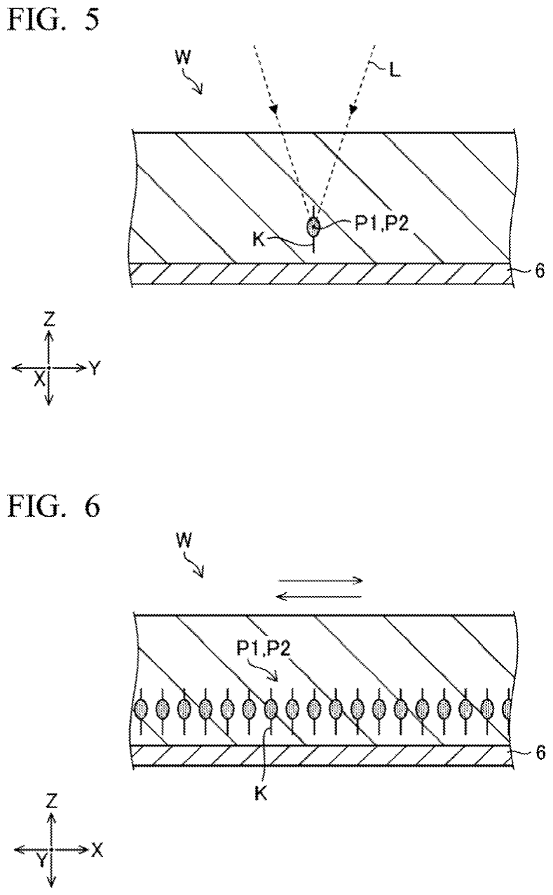

The laser processing control unit 42 controls the movement mechanism 14 and the laser head 16 to execute laser processing for each of the streets CH1 and CH2 of the wafer W. This laser processing consists of first laser processing that forms the laser processing area P1 (refer to FIG. 5) inside the wafer W along each street CH1, and second laser processing that forms the laser processing area P2 (refer to FIG. 5) inside the wafer W along each street CH2.

FIGS. 5 and 6 are diagrams for describing the formation of the laser processing areas P1 and P2 inside the wafer W. As shown in FIGS. 5 and 6, the laser processing control unit 42 drives the movement mechanism 14 to cause the table 12 to rotate in the 0 direction on the basis of a result of the alignment detection by the detection control unit 40, thereby making the street CH1 of the streets CH1 and CH2 intersecting with each other parallel to the X direction (the processing feed direction). Next, the laser processing control unit 42 drives the movement mechanism 14 to adjust the position of the table 12 on the basis of the result of the alignment detection by the detection control unit 40, thereby executing an alignment to align a position of an optical axis of the laser head 16 to one end of a first street CH1.

After the alignment described above is completed, the laser processing control unit 42 controls the laser head 16 so that the laser light L focuses at a position with a predetermined depth from the back surface of the wafer W, thereby forming the laser processing area P1 at this light-focusing point.

Next, the laser processing control unit 42 drives the movement mechanism 14 to cause the table 12 to move in the X direction. As a result, while the laser light L is focused inside the wafer W, the laser head 16 is moved relative to the wafer W in the X direction, that is, the laser head 16 is moved relative to the wafer W in the X direction along the first street CH1. As a result, a one-layer (single-layer) of laser processing area P1 is formed inside the wafer W along the first street CH1. Moreover, when the laser processing area P1 is formed, a crack K occurs in a thickness direction (Z direction) of the wafer W with this laser processing area P1 serving as a starting point.

When the number of layers in the laser processing area P1 (the laser processing area P2) is single, the laser processing control unit 42 drives the movement mechanism 14 after the laser processing area P1 corresponding to the first street CH1 is formed to align a position of the optical axis of the laser head 16 with one end of the second street CH1. Then, the laser processing control unit 42 drives the movement mechanism 14 to cause the table 12 to move in the X direction while the laser head 16 focuses the laser light L inside the wafer W. As a result, the laser processing area P1 is formed inside the wafer W along a second street CH1.

Similarly, the laser processing area P1 is formed inside the wafer W along all streets CH1, and the first laser processing is completed. After the first laser processing is completed, the laser processing control unit 42 drives the movement mechanism 14 to rotate the table 12 by 90 degrees, thereby making each street CH2 parallel to the X direction. Then, the laser processing control unit 42 controls the movement mechanism 14, the laser head 16, and the like to execute the second laser processing to form the laser processing area P2 inside the wafer W along all the street CH2, similarly to the first laser processing described above.

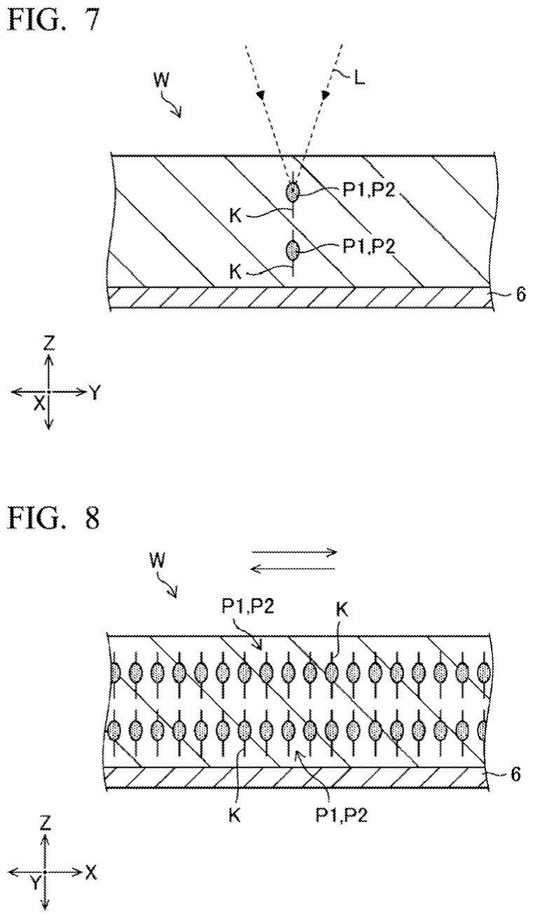

FIGS. 7 and 8 are diagrams for describing the formation of a plurality of layers of laser processing areas P1 and P2 inside the wafer W. As shown in FIGS. 7 and 8, when the wafer W is thick, the laser processing control unit 42 executes the formation of a plurality of layers (two or more layers) of laser processing areas P1 and P2 inside the wafer W along the streets CH1 and CH2. In this case, the laser processing control unit 42 continuously executes the formation of a plurality of layers of laser processing area P1 for each street CH1, and continuously executes the formation of a plurality of layers of laser processing area P2 for each street CH2.

Specifically, after a first layer of laser processing area P1 corresponding to the first street CH1 is formed as described in FIGS. 5 and 6 described above, the laser processing control unit 42 changes the focusing position of the laser tight L emitted from the laser head 16 to a position shallower than the first layer of laser processing area P1 inside the wafer W (a position above in the Z direction). Next, the laser processing control unit 42 drives the movement mechanism 14 to cause the table 12 to move in the X direction, thereby repeatedly forming a second layer of laser processing area P1. As a result, the second layer of laser processing area P1 is formed along the first street CH1. Similarly, a third and subsequent layers of laser processing area P1 can be formed along the first street CH1.

Then, the laser processing control unit 42 similarly forms the plurality of layers of laser processing areas P1 and P2 for each of the streets CH1 and CH2 for the remaining street CH1 or CH2.

When the laser processing device 10 of the present embodiment executes laser processing on the wafer W, it evaluates the processing states of the laser processing areas P1 and P2 in real time. Here, the evaluation of the processing states of the laser processing areas P1 and P2 is to evaluate whether a crack K (the laser processing areas P1 and P2), which is a starting point when the wafer W is cut along the streets CH1 and CH2, is appropriately formed. Note that the evaluation of this processing states also includes evaluation of the extension state of the crack K extending front the laser processing areas P1 and P2.

Specifically, the laser processing device 10 detects and analyzes plasma light LP generated at the processing point SP inside the wafer W in real time during the laser processing, thereby evaluating the processing states of the laser processing areas P1 and P2 in real time. In addition, the laser processing device 10 corrects the emission conditions of the laser light L emitted from the laser light source 30 in real time on the basis of a result of detecting the plasma light LP in real time.

The signal acquisition unit 44 operates the photodiodes 20 and 36 during the laser processing, and repeatedly (continuously) outputs a plasma light detection signal, which is a detection signal of the plasma light LP output from the photodiodes 20 and 36, to the evaluation unit 48 and the correction control unit 50. Note that in the present embodiment, since pulse laser light is used as the laser light L for laser processing, a signal indicating the plasma light LP is periodically generated in the plasma light detection signal.

The processing position determination unit 46 monitors the movement mechanism 14 and the laser head 16 during the laser processing to repeatedly acquire the focusing position of the laser light L of the laser head 16 in the XY plane and the focusing position of the laser light L in the Z direction. As a result, the processing position determination unit 46 can determine a processing position of laser processing [a position in the XY plane and a processing depth position (a processing height position) in the Z direction] in real time. Furthermore, the processing position determination unit 46 can determine whether the focusing position (the processing point SP) of the laser light L is positioned at the intersection CR between the street CH1 and the street CH2 described above (refer to FIG. 2) during the second laser processing. Then, each time the processing position determination unit 46 determines the processing position for laser processing, it sequentially outputs a result of determining the processing position to the evaluation unit 48 and the correction control unit 50.

Each time the plasma light detection signals for each of the photodiodes 20 and 36 are repeatedly input from the signal acquisition unit 44 during the laser processing, the evaluation unit 48 evaluates the processing states of the laser processing areas P1 and P2 on the basis of a result of analyzing these plasma light detection signals. Specifically, the evaluation unit 48 evaluates the processing states of the laser processing areas P1 and P2 by referring to the data table for evaluation 54 on the basis of the result of analyzing the plasma light detection signals.

The result of analyzing the plasma light detection signals includes, for example, at least any one of a light emission intensity, a light emission timing, a light emission time (period, length), and a plasma light emission period of the plasma light LP, obtained by analyzing the plasma light detection signals. Moreover, this analysis result may include a shape of the plasma light LP that can be detected based on the plasma light detection signals. Furthermore, if the plasma light LP is detected by an imaging device that can acquire wavelength information (color information) of the plasma light LP instead of the photodiode 20 and 36, the result of analyzing the plasma light detection signals may also include wavelength information of the plasma light LP.

In the data table for evaluation 54, evaluation data for evaluating the processing states of the laser processing areas P1 and P2 is obtained and stored in advance through experiments, simulations, or the like. This evaluation data stores a plurality of combinations of the result of analyzing the plasma light detection signals described above and a result of evaluating the processing states of the laser processing areas P1 and P2 (for example, generation states and processing efficiency of the laser processing areas P1 and P2). As a result, each time the plasma light detection signals for each of the photodiodes 20 and 36 are repeatedly input from the signal acquisition unit 44, the evaluation unit 48 can evaluate the processing states of the laser processing areas P1 and P2 by referring to the data table for evaluation 54 on the basis of the result of analyzing these plasma light detection signals. As a result, it is possible to evaluate whether the laser processing areas P1 and P2 are appropriately generated.

In particular, when the processing point SP of the second laser processing along the street CH2 reaches the intersection CR during the second laser processing, the laser light L is scattered by the laser processing area P1 that is previously formed at the intersection CR during the first laser processing, and the like. As a result, the laser processing area P2 and the crack K may not be appropriately formed in some cases. In this case, there is a possibility that a connection state between a crack K extending from the laser processing area P1 and a crack K extending from the laser processing area P2 at the intersection CR may be insufficient, and cutting at the intersection CR may not be executed correctly. Therefore, when the processing point SP of the second laser processing is positioned at the intersection CR on the basis of the result of determining the processing position input from the processing position determination unit 46, the evaluation unit 48 evaluates whether the laser processing area P2 is appropriately formed.

The correction control unit 50 corrects the emission conditions of the laser light L emitted from the laser light source 30 during the laser processing as necessary. The emission conditions of the laser light L include at least any one of power of the laser light L, a frequency of the laser light L. and optical conditions of an optical system within the laser head 16.

Specifically, each time the plasma light detection signals and the result of determining the processing position are input front the signal acquisition unit 44 and the processing position determination unit 46 during the laser processing, the correction control unit 50 executes determination of the processing depth position of the laser processing the processing point SP) in the Z direction, determination of the light-emission state of the plasma light LP corresponding to the processing depth position, and correction of the emission conditions of the laser light L.

First, the correction control unit 50 determines the processing depth position of the laser processing (processing point SP) in the Z direction (hereinafter simply referred to as a “processing depth position”) in real time on the basis of the result of determining the processing position that is repeatedly input from the processing position determination unit 46 during the laser processing. Then, the correction control unit 50 determines the light-emission state of the plasma light LP corresponding to the processing depth position of the processing point SP by referring to the data table for correction 56 on the basis of the result of determining the processing depth position.

The data table for correction 56 includes a plurality of combinations of the processing depth position of the processing point SP and the light-emission state of the plasma light LP corresponding to this processing depth position, which are obtained in advance through experiments, simulations, or the like. Here, the light-emission state of the plasma light LP includes any one of items similar to the results of analyzing the plasma light detection signals described above, such as the light emission intensity, light emission timing, light emission time, light emission period, and shape of the plasma light LP. As a result, the correction control unit 50 can determine the light-emission state (hereinafter referred to as a reference light-emission state) of the plasma light LP corresponding to the processing depth position by referring to the data table for correction 56 on the basis of the result of determining the processing depth position.

Next, each time the plasma light detection signals of the photodiodes 20 and 36 are repeatedly input from the signal acquisition unit 44 during the laser processing, the correction control unit 50 corrects the emission conditions of the laser light L emitted from the laser light source 30 as necessary on the basis of these plasma light detection signals and the results of determining the previous reference light-emission state. Specifically, the correction control unit 50 corrects the emission conditions of the laser light L from the laser light source 30 via the laser processing control unit 42 to keep the light-emission state of the plasma light LP at the current processing point SP, obtained by analyzing the plasma light detection signals, constant at the reference light-emission state.

In this manner, the correction control unit 50 executes so-called feedback control to correct the emission conditions of the laser light L of the laser light source 30 in real time on the basis of the result of analyzing the plasma light detection signal during the laser processing and the result of determining the processing depth position. Here, a certain relationship is established between the light-emission state of the plasma light LP at the processing point SP and the processing states (generation state and processing efficiency) of the laser processing areas P1 and P2. For this reason, the processing states of the laser processing areas P1 and P2 are kept constant for each processing depth position of the processing point SP by the feedback control described above.

The display control unit 52 causes the monitor 22 to display photographed image data input from the infrared camera 18, various setting screens of the laser processing device 10, and the like. In addition, when an abnormality has occurred in the processing states of the laser processing areas P1 and P2 during the laser processing of the wafer W on the basis of the result of evaluating the processing states of the laser processing areas P1 and P2 by the evaluation unit 48, the display control unit 52 causes the monitor 22 to display warning information 58 indicating that fact.

Note that the laser processing control unit 42 stops the laser processing of the wafer W when an abnormality has occurred in the processing states on the basis of the result of evaluating the processing states of the laser processing areas P1 and P2 by the evaluation unit 48.

### [Action of First Embodiment]

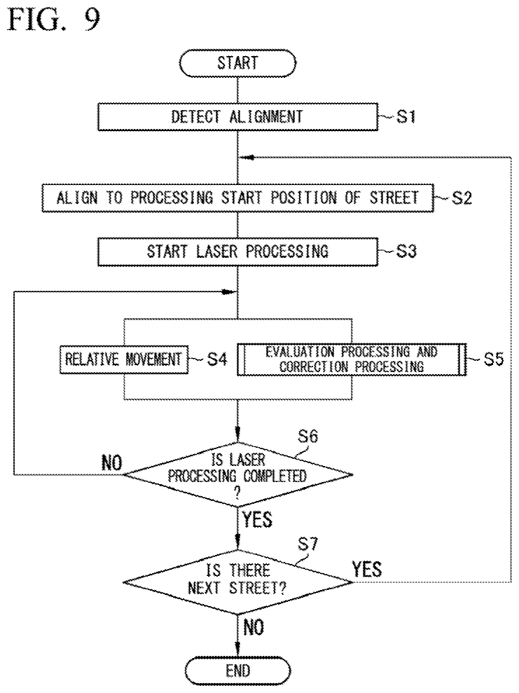

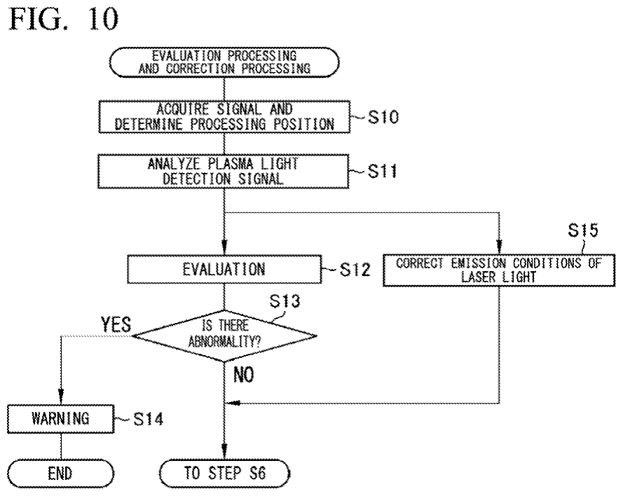

FIG. 9 is a flowchart which shows a flow of laser processing of the wafer W by the laser processing device 10 of the first embodiment according to the laser processing method of the present invention. FIG. 10 is a flowchart which shows a flow of processing in step S5 in FIG. 9 (evaluation processing by the evaluation unit 48 and correction processing by the correction control unit 50).

As shown in FIG. 9, if the wafer W to be processed (product wafer) is adsorbed and held on the table 12, the detection control unit 40 of the control device 24 is operated. The detection control unit 40 controls the movement mechanism 14 and the infrared camera 18 to acquire photographed image data of the alignment reference of the wafer W. Then, the detection control unit 40 analyzes this photographed image data and performs alignment detection to detect the positions of each of the streets CH1 and CH2 of the wafer W (step S1).

When the alignment detection is completed, the laser processing control unit 42 is operated to start the laser processing of the street CH1.

First, the laser processing control unit 42 drives the movement mechanism 14 based on a result of the alignment detection by the detection control unit 40 to execute alignment to align the optical axis of the laser head 16 with one end of the first street CH1 (step S2). If this alignment is completed, the laser processing control unit 42 controls the laser head 16 to focus the laser light L on a position with a predetermined depth from the back surface of the wafer W. As a result, the first laser processing is started, and the laser processing area P1 is formed inside the wafer W (step S3).

Next, the laser processing control unit 42 drives the movement mechanism 14 to cause the table 12 to move in the X direction, thereby causing the laser head 16 to move relative to the wafer W in the X direction (step S4). As a result, the laser processing region P1 along the first street CH1 is formed inside the wafer W. Note that when the wafer W is thick, the laser processing control unit 42 controls the movement mechanism 14 and the laser head 16 to form the plurality of layers of laser processing area P1 along the first street CH1.

If the first laser processing of the wafer W is started, the signal acquisition unit 44, the processing position determination unit 46, the evaluation unit 48, and the correction control unit 50 of the control device 24 are operated. As a result, the evaluation processing of the processing state of the laser processing area P1 and the correction processing of the emission conditions of the laser light L emitted from the laser light source 30 are executed during the first laser processing (step S5).

As shown in FIG. 10, the signal acquisition unit 44 operates the photodiodes 20 and 36 during the first laser processing and repeatedly acquires plasma light detection signals from the photodiodes 20 and 36 (step S10, corresponding to the detection process of the present invention). In addition, at the same time, the processing position determination unit 46 monitors the movement mechanism 14 and the laser head 16 during the first laser processing, thereby determining the processing position of the first laser processing and outputting a result of the determining the processing position to the evaluation unit 48 and the correction control unit 50 repeatedly (step S10). As a result, during the first laser processing, the plasma light LP generated at the processing point SP and the processing position are detected in real time.

The evaluation unit 48 refers to the data table for evaluation 54 on the basis of a result of analyzing a plasma light detection signal input from the signal acquisition unit 44, and evaluates the processing state (generation state and processing efficiency) of the laser processing area P1 in real time (steps S11 and S12, corresponding to the evaluation process of the present invention). At this time, the evaluation unit 48 can evaluate the processing state of the laser processing area P1 for each processing position on the basis of the result of determining the processing position input from the processing position determination unit 46.

When an abnormality occurs in the processing state of laser processing area P1 on the basis of the evaluation of the processing state of laser processing area P1 by the evaluation unit 48 (YES in step S13), the display control unit 52 causes the monitor 22 to display the warning information 58 indicating that fact (step S14). This allows the operator to be notified of the occurrence of an abnormality. In this case, the laser processing control unit 42 stops the first laser processing of the wafer W.

On the other hand, the correction control unit 50 determines the reference light-emission state of the plasma light LP corresponding to the processing depth position of the processing point SP by referring to the data table for correction 56 on the basis of a result of determining the processing position input from the processing position determination unit 46.

Next, the correction control unit 50 analyzes a plasma light detection signal input from the signal acquisition unit 44 to determine the light-emission state of the plasma light LP at the current processing point SP, and corrects the emission conditions of the laser light L of the laser light source 30 via the laser processing control unit 42 so that the light emission state is kept constant at the reference light emission state (steps S11 and S15, corresponding to the correction control process of the present invention). As a result, the emission conditions of the laser light L are corrected in real time so that the light-emission state of the plasma light LP, that is, the processing state of the laser processing area P1, is kept constant during the first laser processing.

Then, when no abnormality has occurred in the processing state of the laser processing area P1 (NO in step S13), the processing proceeds to step S6 of FIG. 9.

Returning to FIG. 9, the processing from step S4 and step S5 (step S10 to step S15) described above are repeatedly executed until the first laser processing of a single layer or a plurality of layers on the first street CH1 is completed (NO in step S6). In the same manner, the first laser processing on the remaining street CH1, the evaluation of the processing state of the laser processing area P1, and the correction of the emission conditions of the laser light L are repeatedly executed (YES in step S7, step S2 to step S6).

If the first laser processing of all street CH1 is completed, the laser processing control unit 42 drives the movement mechanism 14 on the basis of a result of the alignment detection described above to execute an alignment to align a position of the optical axis of the laser head 16 to one end of the first street CH2 (YES in step S7, step S2).

Next, focusing of the laser light L on the inside of the wafer W by the laser head 16 and movement of the table 12 in the X direction by the movement mechanism 14 are started under control of the laser processing control unit 42, and thereby second laser processing is started (step S3). As a result, the laser processing area P2 is formed inside the wafer W along the first street CH2. Note that when the wafer W is thick, the laser processing control unit 42 controls the movement mechanism 14 and the laser head 16 to form the plurality of layers of laser processing area P2 along the first street CH2.

During the second laser processing, as in the first laser processing described above, the evaluation of the processing state of the laser processing area P2 by the evaluation unit 48 and the correction of the emission conditions of the laser light L by the correction control unit 50 are repeatedly executed (step S5). In the second laser processing as described above, there is a possibility that the laser processing area P2 and the crack K may not be formed appropriately at the intersection CR, but the evaluation unit 48 can evaluate whether the laser processing area P2 and the crack K are appropriately present at the intersection CR in real time. In addition, the correction control unit 50 executes the correction of the emission conditions of the laser light L (for example, output correction), and thereby it is possible to appropriately form the laser processing area P2 and the crack K at the intersection CR.

The processing of step S4 and step S5 (from step S10 to step S15) described above are repeatedly executed until the second laser processing of a single layer or a plurality of layers on the first street CH2 is completed (NO in step S6). In the same manner, the second laser processing on the remaining street CH2, the evaluation of the processing state of the laser processing area P2, and the correction of the emission conditions of the laser light L are repeatedly executed (YES in step S7, step S2 to step S6). As a result, the laser processing on all streets CH1 and CH2 of the wafer W is completed (NO in step S7).

In the laser processing device 10 of the first embodiment as described above, the processing states of laser processing areas P1 and P2 can be evaluated in real time by detecting plasma light LP generated at the processing point SP in real time using the photodiodes 20 and 36 during the laser processing of the product wafer W. As a result, there is no need to execute the evaluation of the processing state using the conventional sample wafer, so that the operator can be notified immediately if an abnormality occurs. This makes it possible to reduce the number of defective wafers W (product wafers).

In addition, by detecting the plasma light LP generated at the processing point SP in real time using the photodiodes 20 and 36, the emission conditions of the laser light L of the laser light source 30 can be corrected in real time so that the light-emission state of the plasma light LP at the processing point SP can be kept constant at the reference light-emission state. As a result, the processing states of the laser processing areas P1 and P2 are kept constant for each processing depth position.

Furthermore, in the laser processing device 10 of the first embodiment, even if the laser processing areas P1 and P2 are not generated inside the wafer W because processing defects in the laser processing occur due to an abnormality in the thickness of the wafer W or an abnormality in the processing height control of the laser processing by the laser processing device 10, this can be confirmed in real time. For this reason, this prevents an occurrence of undivided wafers in a post-process and a decrease in a yield of device mass production processing. As a result, the yield of device mass production processing can be improved.

Furthermore, it is possible to confirm in real time processing defects of the laser processing, which are caused by scattering of the laser light 1 or the like during subsequent laser processing according to the crack K extending from the laser processing areas P1 and P2 formed by previous laser processing in the laser processing device 10 of the first embodiment.

For example, as shown in FIG. 8, when the second layer of laser processing area P2 is formed after the first layer of laser processing area P1 is formed inside the wafer W along streets CH1 and CH2, an abnormality may occur in the crack extension from the first layer laser processing area P1 (the crack K is formed long). In this case, since the laser light L during the laser processing of the second layer is focused in the crack K that extends from the laser processing area P1 of the first layer, there is a concern that the laser light L may not be absorbed by the wafer W and the laser processing area P2 and the crack K may not be generated in the laser processing of the second layer. As a result, in a cutting process that is a post-process, the wafer W cannot be separated into chips, resulting in undivided chips. Furthermore, there are concerns that the laser light L of the laser processing of the second layer reflected inside the crack K of the first layer scatters at an angle on a surface side (pattern side) of the wafer W, causing a thermal damage to a device pattern and circuit unit to lead to circuit damage.

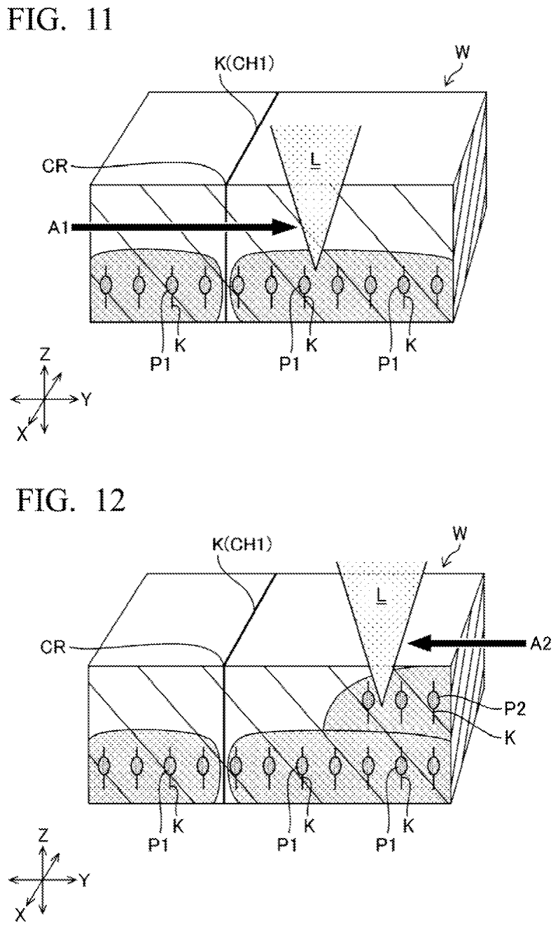

Furthermore, even if laser light L of laser processing of the second layer continues processing without being affected by the crack K formed in the laser processing of the first layer, there is a possibility that processing defects of the laser processing may occur at the intersection CR between the street CH1 and the street CH2 (refer to FIGS. 11 to 14, which will be described below).

FIG. 11 is a diagram for describing the laser processing of a first layer on the street CH2, which is executed near the intersection CR after the laser processing of two layers on the street CH1. FIGS. 12 to 14 are diagrams for describing the laser processing of a second layer on the street CH2, which is executed near the intersection CR after the laser processing of two layers on the street CH1. Note that a symbol A1 in FIG. 11 indicates a processing feed direction of the laser processing of the first layer, and a symbol A2 in FIGS. 12 to 14 indicates a processing feed direction of the laser processing of the second layer. Moreover, the symbol K (CH1) in FIGS. 11 to 14 indicates a crack formed by the laser processing of two layers on the street CH1.

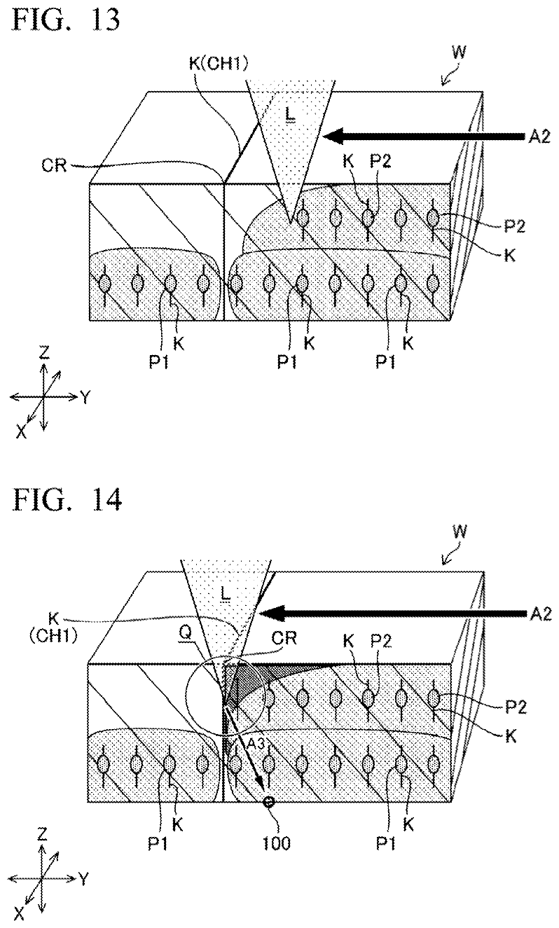

As shown in FIGS. 11 to 13, after the laser processing of two layers on the street CH1, the laser processing on the street CH2 is started, and then the laser processing of the second layer on the street CH2 is started. Even if this laser processing of the second laser progresses without being affected by the crack K formed in the laser processing of the first layer, if the laser processing of the second layer reaches an area perpendicular to the crack K (CH1) (near the intersection CR), as shown in FIG. 14, processing defects may occur in the laser processing.

Specifically, a phenomenon may occur in which, just before the crack K formed in the laser processing of the second layer crosses perpendicularly to the crack K (CH1), the formation of the crack K progresses first by laser processing and the crack K is connected to the crack K (CH1). In this case, the laser light L of the laser processing of the second layer is emitted to the crack K (CH1) without being absorbed or attenuated by the wafer W. When this crack K (CH1) is irradiated with high-intensity laser light L, a scattering distance of a reflected light of the laser light L tends to increase, as shown by an arrow A3 in FIG. 14, and them is a high probability of device damage (occurrence of a thermal damage area 100). In addition, as indicated by a symbol Q in FIG. 14, there is a possibility that an area where the laser processing area P2 is not generated may occur. Incidentally, since an event in which such crack formation precedes near the intersection CR depends on fluctuations in laser output and minute changes in processing height position, and it occurs suddenly, it is difficult to grasp the phenomenon.

Conventionally, the thermal damage area 100 due to such thermal damage has been detected by an image inspection device, but it has been difficult to detect a minute thermal damage area 100 using the image inspection device. On the other hand, by detecting the plasma light LP generated at the processing point SP in real time as in the first embodiment, it is possible to clearly grasp the occurrence thereof even in the minute thermal damage area 100. Similarly, the phenomenon in which the laser processing area P2 and the crack K are not generated can also be clearly grasped.

### Second Embodiment

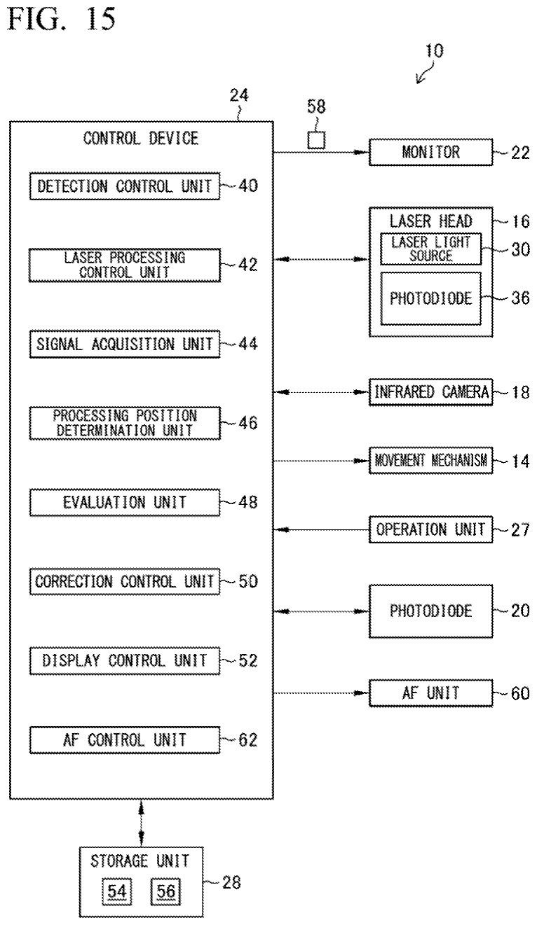

FIG. 15 is a block diagram of the laser processing device 10 of a second embodiment. As shown in FIG. 15, the laser processing device 10 of the second embodiment has an autofocus (AF) function that keeps a work distance, which is a distance between the back surface of the wafer W and the laser head 16, constant in response to an unevenness of the back surface of the wafer W during the laser processing.

The laser processing device 10 of the second embodiment has the basically same configuration as that of the laser processing device 10 of the first embodiment, except that it includes an AF unit 60 and the control device 24 functions as an AF control unit 62. For this reason, the same reference numerals are given to the same elements in function or configuration as those in the first embodiment, and the description thereof will be omitted.

The AF unit 60 uses, for example, a known piezo unit, and is capable of displacing the laser head 16 in the Z direction under control of an AF control unit 62, which will be described below.

For example, the AF control unit 62 executes known AF control to drive the AF unit 60 so that a work distance (a focal position of the objective lens 32 in the Z direction) is kept constant during the laser processing on the basis of a result of measuring a distance from the laser head 16 to the back surface of the wafer W by a distance measuring sensor (not shown) (the infrared camera 18 may also be used) during the laser processing.

When such AF control is executed, the AF unit 60 may oscillate (hunting phenomenon may occur) in an area where the back surface of the wafer W has a large displacement (for example, an outer edge of the wafer W). Even in this case, the oscillation of the AF unit 60 can be detected by the evaluation unit 48 monitoring a plasma light emission period on the basis of a plasma light detection signal repeatedly input from the signal acquisition unit 44.

### [Laser Processing Device of Third Embodiment and Fourth Embodiment]

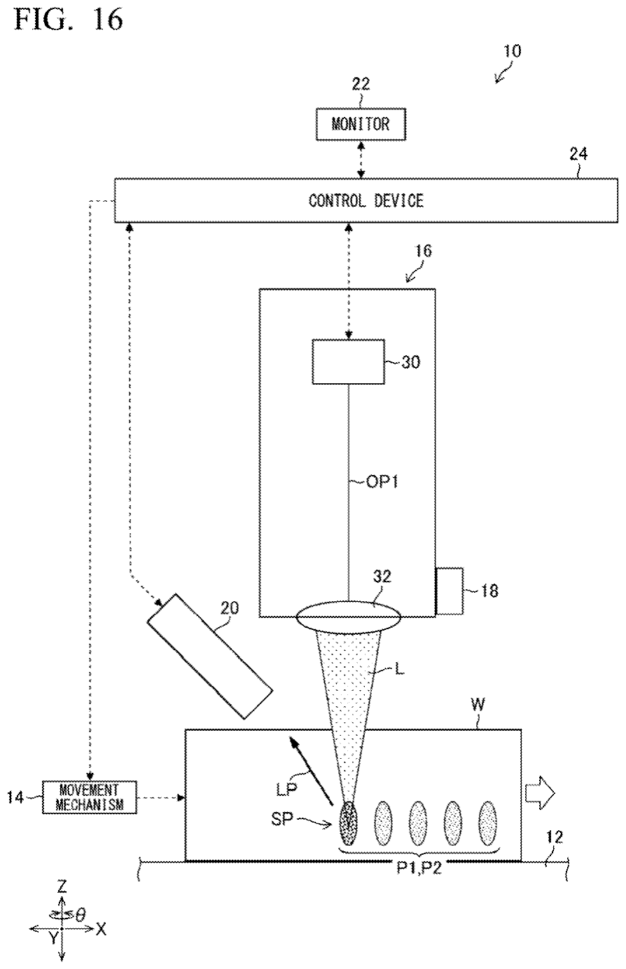

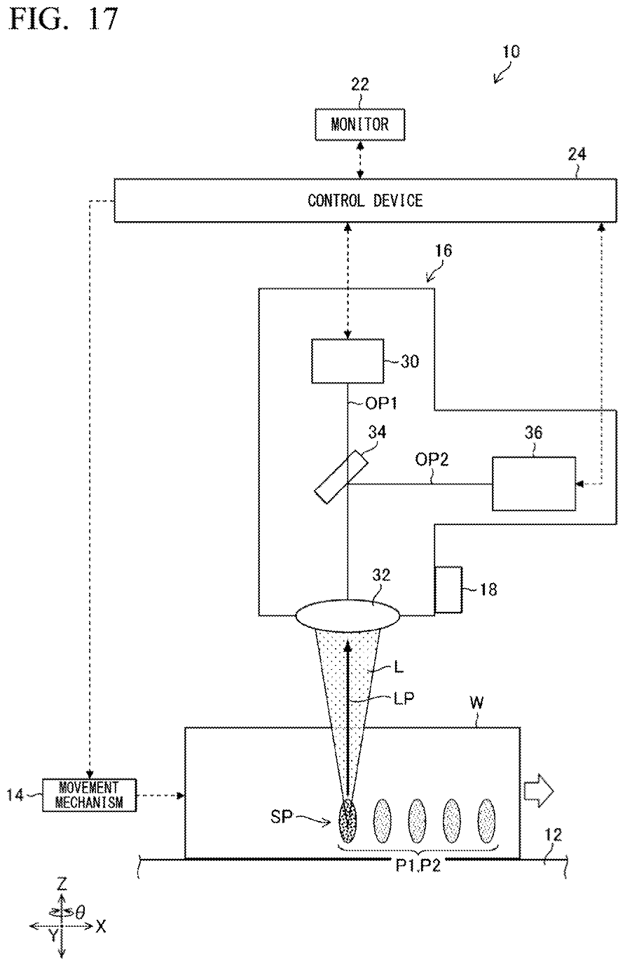

FIG. 16 is a diagram which shows a laser processing device 10 of a third embodiment. FIG. 17 is a diagram which shows a laser processing device 10 according to a fourth embodiment. In the laser processing device 10 of each of the embodiments described above, two types of photodiodes 20 and 36 are used to detect the plasma light LP in real time during the laser processing of the wafer W, but the present invention is not limited to this.

For example, as shown in FIG. 16, the laser processing device 10 of the third embodiment is obtained by omitting the photodiode 36 from the laser processing device 10 of each of the embodiments described above. For this reason, the laser processing device 10 of the third embodiment executes the evaluation of the processing states of the laser processing areas P1 and P2 by the evaluation unit 48 and the correction of the emission conditions of the laser light L by the correction control unit 50 on the basis of only a result of detecting the plasma light LP by the photodiode 20 during the laser processing. Since the photodiode 20 can directly detect the plasma light LP generated inside the wafer W (detect it without using the objective lens 32 or the like), it is possible to increase a detection accuracy of the plasma light U), compared to when the plasma light LP is detected via, like the photodiode 36, the objective lens 32 or the like.

Further, as shown in FIG. 17, the laser processing device 10 of the fourth embodiment is obtained by omitting the photodiode 20 from the laser processing device 10 of each of the embodiments described above. For this reason, the laser processing device 10 of the fourth embodiment executes the evaluation of the processing states of the laser processing areas P1 and P2 by the evaluation unit 48 and the correction of the emission conditions of the laser light L by the correction control unit 50 on the basis of only a result of detecting the plasma light LP by the photodiode 36 during the laser processing. When the objective lens 32 is a precision lens, a sufficient work distance cannot be ensured, making it difficult for the photodiode 20 to detect the plasma light LP. For this reason, in this case, it is preferable to detect the plasma light LP using the photodiode 36 disposed on the optical path OP2 branching from the optical path OP1 in the laser head 16.

### [Others]

In each of the embodiments described above, the evaluation unit 48 evaluates the processing states of the laser processing areas P1 and P2 by referring to the data table for evaluation 54 on the basis of the result of analyzing a plasma light detection signal. However, the present invention is not limited thereto. For example, a learned model is generated in advance by machine learning using the result of the analysis of the plasma light detection signal and the result of the evaluation of the processing states of the laser processing areas P1 and P2 as teacher data. Then, the evaluation unit 48 may evaluate the processing states of the laser processing areas P1 and P2 using the learned model on the basis of the result of the analysis of the plasma light detection signal.

In each of the embodiments described above, although the plasma light LP is detected using the photodiodes 20 and 36 to execute both the evaluation of the processing states of the laser processing areas P1 and P2 and the correction of the emission conditions of the laser light L emitted from the laser light source 30, only one of these (only evaluation or only correction) may be executed.

In each of the embodiments described above, the photodiodes 20 and 36 are used to detect the plasma light LP, but the plasma light LP may be detected using various types of known optical detection sensors (imaging devices, cameras). At this time, when an image device capable of color imaging the plasma light LP is used, the processing states of the laser processing areas P1 and P2 can be evaluated on the basis of wavelength information (color information) of the plasma light LP generated at the processing point SP.

### EXPLANATION OF REFERENCES

4 Chip
6 Device layer
10 Laser processing device
12 Table
14 Movement mechanism
16 laser head
18 Infrared camera
20 Photodiode
22 Monitor
24 Control device
27 Operation unit
28 Storage unit
30 Laser light source
32 Objective lens
34 Half mirror
36 Photodiode
40 Detection control unit
42 Laser processing control unit
44 Signal acquisition unit
46 Processing position determination unit
48 Evaluation unit
50 Correction control unit
52 Display control unit
54 Data table for evaluation
56 Data table for correction
58 Warning information
60 AF unit
62 AF control unit
100 Thermal damage area
CH1 Street
CH2 Street
CR Intersection
K Crack
L Laser light
LP Plasma light
Nd Semiconductor laser excitation
OP1 Optical path
OP2 Optical path
P1 Laser processing area
P2 laser processing area
SP Processing point

What is claimed is:

1. A laser processing device that irradiates a workpiece with laser light by aligning light-focusing points from a laser head to an inside of the workpiece while moving the laser head relative to the workpiece and executes laser processing of forming a laser processing area inside the workpiece along a street of the workpiece, comprising:
a detection sensor configured to detect plasma light generated at a processing point of the laser light that is focused on the inside of the workpiece by the laser head during the laser processing; and
an evaluation unit configured to evaluate a processing state of the laser processing area on the basis of a detection signal of the detection sensor during the laser processing.

2. The laser processing device according to claim 1, wherein the detection sensor is provided separately from the laser head.

3. The laser processing device according to claim 1,
wherein the laser head includes:
a light source that emits the laser light,
an objective lens that focuses the laser light emitted from the light source on the inside of the workpiece, and
an optical branching element that is disposed on an optical path of the laser light incident on the objective lens and causes a part of the plasma light incident on the objective lens from the workpiece to branch from the optical path,
wherein the detection sensor is provided in the laser head and detects the plasma light branched by the optical branching element.

4. The laser processing device according to claim 1,
wherein the laser head includes:
a light source that emits the laser light,
an objective lens that focuses the laser light emitted from the light source on the inside of the workpiece, and
an optical branching element that is disposed on an optical path of the laser light incident on the objective lens and causes a part of the plasma light incident on the objective lens from the workpiece to branch from the optical path,
wherein the detection sensor includes,
a first detection sensor that is provided separately from the laser head, and
a second detection sensor that is provided in the laser head and detects the plasma light branched by the optical branching element.

5. The laser processing device according to claim 1,
wherein the workpiece has a plurality of first streets and a plurality of second streets intersecting each other to form a lattice shape,
the laser processing includes first laser processing of forming the laser processing area inside the workpiece along the first street for each of the first streets, and second laser processing of forming the laser processing area inside the workpiece along the second street for each of the second streets after completion of the first laser processing, and
the evaluation unit evaluates whether the laser processing area is formed by the second laser processing as the processing state at an intersection of the first street and the second street during the second laser processing.

6. The laser processing device according to claim 1,
wherein the laser light is pulse laser light, and
the evaluation unit executes evaluation of the processing state on the basis of a result of detecting at least one of a light emission period, a light emission intensity, a light emission timing, and a light emission time of the plasma light based on the detection signal of the detection sensor.

7. The laser processing device according to claim 1, further comprising a correction control unit configured to correct emission conditions of the laser light emitted from the laser head on the basis of a detection signal of the detection sensor during the laser processing, and to keep a constant light emission state of the plasma light generated at the processing point.

8. A laser processing device that irradiates a workpiece with laser light by aligning light-focusing points from a laser head to an inside of the workpiece while moving the laser head relative to the workpiece and executes laser processing of forming a laser processing area inside the workpiece along a street of the workpiece, comprising:
a detection sensor configured to detect plasma light generated at a processing point of the laser light that is focused on the inside of the workpiece by the laser head during the laser processing,
an evaluation unit configured to evaluate a processing state of the laser processing area on the basis of a detection signal of the detection sensor during the laser processing, and
a correction control unit configured to correct emission conditions of the laser light emitted from the laser head on the basis of a detection signal of the detection sensor during the laser processing, and to keep a constant light emission state of the plasma light generated at the processing point.

9. A laser processing method of irradiating a workpiece with laser light by aligning light-focusing points from a laser head to an inside of the workpiece while moving the laser head relative to the workpiece and executing laser processing of forming a laser processing area inside the workpiece along a street of the workpiece, comprising:
a detection process of detecting plasma light generated at a processing point of the laser light that is focused on the inside of the workpiece by the laser head during the laser processing, and
an evaluation process of evaluating a processing state of the laser processing area on the basis of a detection signal detected in the detection process during the laser processing.

10. A laser processing method of irradiating a workpiece with laser light by aligning light-focusing points front a laser head to an inside of the workpiece while moving the laser head relative to the workpiece and executing laser processing of forming a laser processing area inside the workpiece along a street of the workpiece, comprising:
a detection process of detecting plasma light generated at a processing point of the laser light that is focused on the inside of the workpiece by the laser head during the laser processing, and
a correction control process of correcting emission conditions of the laser light emitted from the laser head on the basis of a detection signal of the detection sensor during the laser processing, and keeping a constant light emission state of the plasma light generated at the processing point.
